(19) United States
(12) Patent Application Publication
(10) Pub. No.: US 2003/0179505 A1
(43) Pub. Date: Sep. 25, 2003

(54) One piece interconnect from channel chip to head slider in a voice coil actuator for a disk drive

(76) Inventors: Eun Kyu Jang, Santa Clara, CA (US); Hyung Jai Lee, Cupertino, CA (US)

Correspondence Address: GREGORY SMITH & ASSOCIATES, 3900 NEWPARK MALL ROAD, 3RD FLOOR, NEWARK, CA, 94560, US

(21) Appl. No.: 10/101,809

(22) Filed: Mar. 19, 2002

(51) Int. Cl. G11B 5/39; G11B 21/16

(52) U.S. Cl. 360/313; 360/245.9

(57) ABSTRACT

A single flex interconnection circuit bonds to a connector, to electronic components including at least preamplifier, and to at least one MR read-write head. The flex interconnection circuit provides the least number of bonds for each of the lines involved. The least number of bonds provides the least parasitic capacitance and inductance on these lines. The method of making the flex interconnection circuit requires the least number of bonding steps, minimizing the manufacturing cost. The invention includes the flex interconnection substrate, flex interconnection circuit built on the substrate, the actuator and disk built from the flex interconnection circuit.

### TECHNICAL FIELD

This invention relates to the interconnection of the read-write head in a head slider to the channel chip in a voice coil actuator used in a disk drive.

### BACKGROUND ART

Disk drives are an important data storage technology, which is based on several crucial components. These components include the interconnection between the read/write heads, which actually communicate with a disk surface containing the data storage medium, and the read/write interfaces of the disk drive. While there has been great progress in disk drives, there are problems, which have yet to be solved.

FIG. 1A illustrates a typical prior art high capacity disk drive 10 including actuator arm 30 with voice coil 32, actuator axis 40, suspension or head arms 50-58 with slider/head unit 60 placed among the disks.

FIG. 1B illustrates a typical prior art high capacity disk drive 10 with actuator 20 including actuator arm 30 with voice coil 32, actuator axis 40, head arms 50-56 and slider/head units 60-66 with the disks removed.

Since the 1980's, high capacity disk drives 10 have used voice coil actuators 20-66 to position their read/write heads over specific tracks. The heads are mounted on head sliders 60-66, which float a small distance off the disk drive surface when in operation. Often there is one head per head slider for a given disk drive surface. There are usually multiple heads in a single disk drive, but for economic reasons, usually only one voice coil actuator.

Voice coil actuators are further composed of a fixed magnet actuator 20 interacting with a time varying electromagnetic field induced by voice coil 32 to provide a lever action via actuator axis 40. The lever action acts to move head arms 50-56 positioning head slider units 60-66 over specific tracks with remarkable speed and accuracy. Actuator arms 30 are often considered to include voice coil 32, actuator axis 40, head arms 50-56 and head sliders 60-66. Note that actuator arms 30 may have as few as a single head arm 50. Note also that a single head arm 52 may connect with two head sliders 62 and 64.

The evolution of disk drives stimulated the computer revolution. While contemporary actuator designs are essential to the progress to date, there remain problems limiting the reliability and capability of disk drives built with contemporary voice actuators. One problem has to do with the method of electrically interconnecting heads to the head interface electronics.

FIG. 2 illustrates a simplified circuit diagram of a disk drive controller Printed Circuit Board (PCB) 1000, with channel interface 1140 controlling MR read/write heads 200-206 of the prior art, using connector 226, flex circuits 224 and 210-216, as well as actuator PCB 220.

Disk drive controller Printed Circuit Board (PCB) 1000 includes computer 1100 interacting with channel interface 1140. Channel controller 1140 controls read-write preamplifier 222, which communicates using separate read differential signal pairs (r+ and r−) and write differential signal pairs (w+ and w−) with the MR read/write heads 200-206.

Note that connector 226 mechanically couples 1150 with connector 230 to electrically couple channel interface 1140 through read-write preamplifier 222 to MR read-write head 200.

Note also that different prior art disk drives may have only one MR read-write head 200, or more than one MR read-write heads (202-206).

The interconnection between MR read-write head 200, preamplifier 222 and connection 226, begins at head slider 60 and involves several distinct circuits which must be soldered together to provide this interconnection. Today, the actuator PCB 220 is connected to separate flex circuits coupling to connector 226 as well as separate flex circuits 210-216, coupling to MR read-write heads 200-206, respectively.

Computer 1100 within embedded disk controller PCB 1000 receives readings of the spin valve voltage V_rd from an analog read/write interface including channel interface 1140 coupled 1152-230-1150-226-224 to read-write preamplifier 220. Computer 1100 also controls the read current Ir_set for read differential signal pair r+ and r−, as well as the write current Iw_set for write differential signal pair w+ and w−.

Coupling 1152 usually involves printed circuit board traces to connector 230. Coupling 1150 indicates the mechanical coupling of connector 230 to connector 226. Connector 226 couples via flex circuit 224 with read-write preamplifier 222 through actuator PCB 220.

Read-write preamplifier 220 couples through actuator PCB 220 via flex circuit 210 to MR read-write head 200. Read-write preamplifier 220 couples through actuator PCB 220 via flex circuit 212 to MR read-write head 202. Read-write preamplifier 220 couples through actuator PCB 220 via flex circuit 214 to MR read-write head 204. Read-write preamplifier 220 couples through actuator PCB 220 via flex circuit 216 to MR read-write head 206.

The process of reading the data storage surface using MR read/write head 200 includes the following. Computer 1100 accesses 1122 a memory 1120. Memory 1120 contains program system 1128. Memory 1120 typically includes a non-volatile memory component. This non-volatile memory component is often used to store program system 1128.

FIGS. 3A, 3B, 3C and 3D illustrate a prior art actuator arm from the top view, detailed portion of top view, side view and front views, respectively.

FIG. 3A illustrates a top view of a prior art actuator arm 30 showing head arm 50, actuator axis 40, and head slider 60 of FIG. 1 with detail region 70 illustrated in FIG. 3B.

FIG. 3B illustrates a top view of detail region 70 of FIG. 3A.

FIG. 3C illustrates a side view of part of detail region 70 of FIG. 3B indicating the interconnections 74-80 via various head sliders as found in the prior art. Each of these labeled interconnections includes two pairs of differential signals. One differential signal pair interconnects a read head to a read interface of the disk drive. The other differential signal pair interconnects a write head to a disk drive write interface.

FIG. 3D illustrates a different perspective on FIG. 3C, illustrating that these signal interconnections 74 may be embodied as various forms of cables attached to a head arm, including flex and ribbon cables.

FIG. 3E illustrates an alternative prior art electrical interconnection scheme for 74-80 traversing along head arm 50, essentially parallel to head arm 50.

FIG. 3E is typical of prior art uses of flex circuitry to interconnect head sliders and disk read/write interfaces. Four individual traces are used for the read differential signal pair (R+, R−) and the write differential signal pair (W+, W−).

The prior art teaches interconnecting multiple pieces of interconnection circuitry 224, 220, and 210 between the read-write head 200 in the head slider 60 and channel interface 1140 coupling 226. Assembling these interconnection circuits with these multiple flex circuits usually includes reflow bonding and/or ultra-sonic bonding of these flex circuits.

FIG. 4 illustrates a prior art method 1500 of making the interconnection circuit from a read-write head 200 to embedded disk controller PCB connector 226.

Arrow 1510 directs the flow of execution from starting operation 1500 to operation 1512. Operation 1512 performs bonding read-write head 200 to flex circuit 210. Arrow 1514 directs execution from operation 1512 to operation 1516. Operation 1516 terminates the operations of this flowchart.

Arrow 1520 directs the flow of execution from starting operation 1500 to operation 1522. Operation 1522 performs bonding flex circuit 210 to actuator PCB 220. Arrow 1524 directs execution from operation 1522 to operation 1516. Operation 1516 terminates the operations of this flowchart.

Arrow 1530 directs the flow of execution from starting operation 1500 to operation 1532. Operation 1532 performs bonding electronic components including at least read-write preamplifier 222 to actuator PCB 220. Arrow 1534 directs execution from operation 1532 to operation 1516. Operation 1516 terminates the operations of this flowchart.

Arrow 1540 directs the flow of execution from starting operation 1500 to operation 1542. Operation 1542 performs bonding flex circuit 224 to actuator PCB 220. Arrow 1544 directs execution from operation 1542 to operation 1516. Operation 1516 terminates the operations of this flowchart.

Arrow 1550 directs the flow of execution from starting operation 1500 to operation 1552. Operation 1552 performs bonding flex circuit 224 to connector 226. Arrow 1554 directs execution from operation 1552 to operation 1516. Operation 1516 terminates the operations of this flowchart.

The prior art teaches several interconnection circuit variations, including three interconnection circuits as discussed above, as well as some examples of two interconnection circuits. The three interconnection circuit scheme contents are referred to as main flex (actuator PCB 220), bridge flex circuit (224) and suspension flexure (210-216). The two interconnection circuits are found in two variations. The first variation contains a main flex circuit (224 plus 220) and suspension flexure (210-216). The second variation contains a main flex circuit (220) and a combined bridge flex circuit with suspension flexure (224 plus 210-216).

In any of the prior art approaches, multiple interconnection circuits are typically bonded together to create electrical couplings using either an ultrasonic bonding process or a reflow bonding process to create the interconnection circuit between connector 226, read-write preamplifier 222, and one or more MR read-write heads 200-206.

While this method of interconnection has achieved widespread production use in the manufacture of disk drives, it has some problems due to the employed bonding process.

Reflow bonding processes apply heat to a solder paste or solid to form a solder joint. The paste or solid is melted, and then allowed to cool to create the solder joint. Ultrasonic bonding processes use ultrasonic energy to form a solder joint at essentially room temperature. Each of these bonds increases parasitic capacitance as well as increases parasitic inductance on the bonded line. Each bonding step increases the manufacturing cost for the interconnection circuit, and consequently, for the voice coil actuators and, ultimately, for the disk drives containing these interconnection circuits.

What is needed is an interconnection circuit minimizing the number of wire bonds on each line. What is further needed is a method of making the interconnection circuit which minimizes the number of bonding steps required to make the interconnections between MR read-write heads, preamplifier and connector.

### SUMMARY OF THE INVENTION

The invention solves at least all the needs discussed in the prior art. The invention includes an interconnection circuit minimizing the number of wire bonds on each line. The invention further includes a method of making the interconnection circuit minimizing the number of bonding steps required to make the interconnections between the MR read-write heads, the preamplifier and the connector.

A single flex interconnection circuit 2000 bonds to connector 226, electronic components including at least preamplifier 222 and at least one MR read-write head 200 (see FIG. 5). Flex interconnection circuit 2000 provides the least number of bonds for each of the lines involved. The invention includes the flex interconnection substrate with bonding sites for connector 226, electronic components and MR read-write heads.

The method 3000 (see FIG. 6A) of making flex interconnection circuits 2000 involves the least number of bonding steps necessary to provide interconnection between connector 226, electronic components including preamplifier 222 and at least one MR read-write head 200. The bonded electronic components may include one or more resistors as well as one or more capacitors. Note that more than one MR read-write head (200-206) may be bonded to flex interconnection circuit 2000 in one operation 3032 of FIG. 6A.

Alternatively, a method 3300 (FIG. 7) coupling connector 226, preamplifier 222 and several MR read-write heads (200-206) may apply the method 3000 of FIG. 6A to interconnect the first MR read-write head 200 and then successively bond other MR read-write heads in operations 3322, 3332, and 3342 of FIG. 7.

The invention includes a method 3500 (FIG. 8) of assembling an actuator using flex interconnection circuit 2000. The invention further includes actuators as the product of the process making them from flex interconnection circuits 2000. The invention includes disk drives made from the process of assembling the inventive actuators into the disk drives.

Both the actuators and disk drives show improved reliability and noise suppression characteristics from minimized number of bonds per line in flex interconnection circuit 2000. Both the actuators and disk drives cost less to manufacture, because of the reduced manufacturing cost of flex interconnection circuit 2000.

These and other advantages of the present invention will become apparent upon reading the following detailed descriptions and studying the various figures of the drawings.

### BRIEF DESCRIPTION OF THE DRAWINGS

FIG. 1A illustrates a typical prior art high capacity disk drive 10 including actuator arm 30 with voice coil 32, actuator axis 40, suspension or head arms 50-58 with slider/head unit 60 placed among the disks;

FIG. 1B illustrates a typical prior art high capacity disk drive 10 with actuator 20 including actuator arm 30 with voice coil 32, actuator axis 40, head arms 50-56 and slider/head units 60-66 with the disks removed;

FIG. 2 illustrates a simplified circuit diagram of a disk drive controller Printed Circuit Board (PCB) 1000, with channel interface 1140 controlling MR read/write heads 200-206 of the prior art, using connector 226, flex circuits 224 and 210-216, as well as actuator PCB 220;

FIG. 3A illustrates a top view of a prior art actuator arm 30 showing head arm 50, actuator axis 40, and head slider 60 of FIG. 1 with detail region 70 illustrated in FIG. 3B;

FIG. 3B illustrates a top view of detail region 70 of FIG. 3A;

FIG. 3C illustrates a side view of part of detail region 70 of FIG. 3B indicating the interconnections 74-80 via various head sliders as found in the prior art;

FIG. 3D illustrates a different perspective on FIG. 3C, illustrating that these signal interconnections 74 may be embodied as various forms of cables attached to a head arm, including flex and ribbon cables;

FIG. 3E illustrates an alternative prior art electrical interconnection scheme for 74-80 essentially parallel to head arm 50;

FIG. 4 illustrates a prior art method 1500 of making the interconnection circuit from a read-write head 200 to embedded disk controller PCB connector 226;

FIG. 5 illustrates a single flex interconnect circuit 2000 providing interconnection between connector 226 via preamplifier 222 and MR read-write head 200;

FIG. 6A illustrates a method 3000 for making flex interconnection circuit 2000, coupling connector 226 through preamplifier 222 with MR read-write head 200;

FIG. 6B illustrates a detail flowchart of operation 3022 of FIG. 6A for bonding electronic components to flex interconnection circuit 2000;

FIG. 7 illustrates a method 3300 for making an interconnection circuit, coupling connector 226 through preamplifier 222 with at least two MR read-write heads using the method 3000 of FIG. 6A; and

FIG. 8 illustrates a method 3500 for assembling a voice coil actuator using an interconnection circuit as the product of the method 3000.

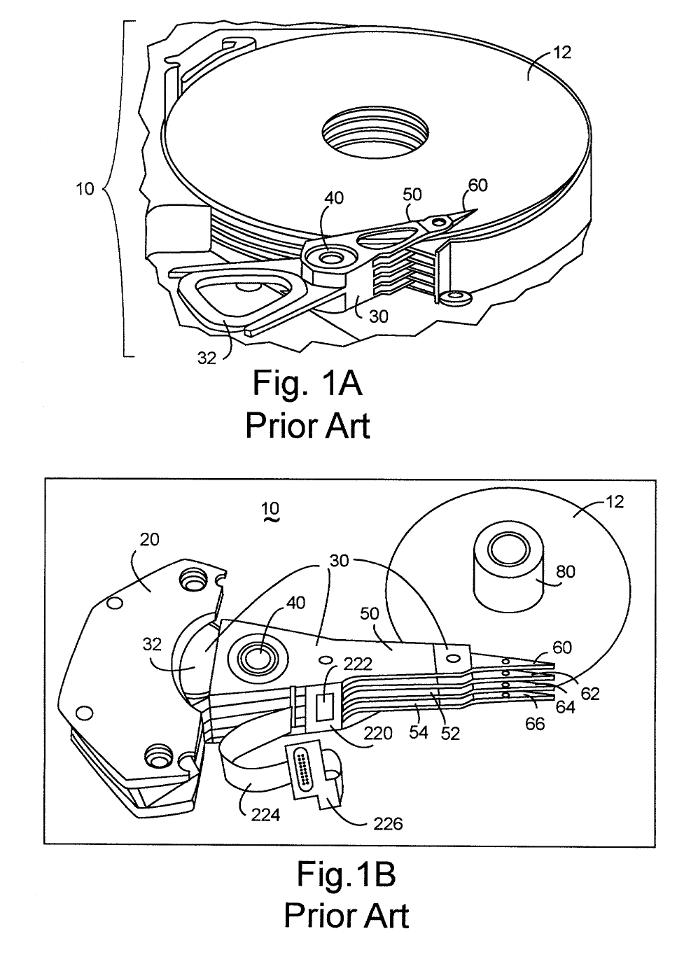

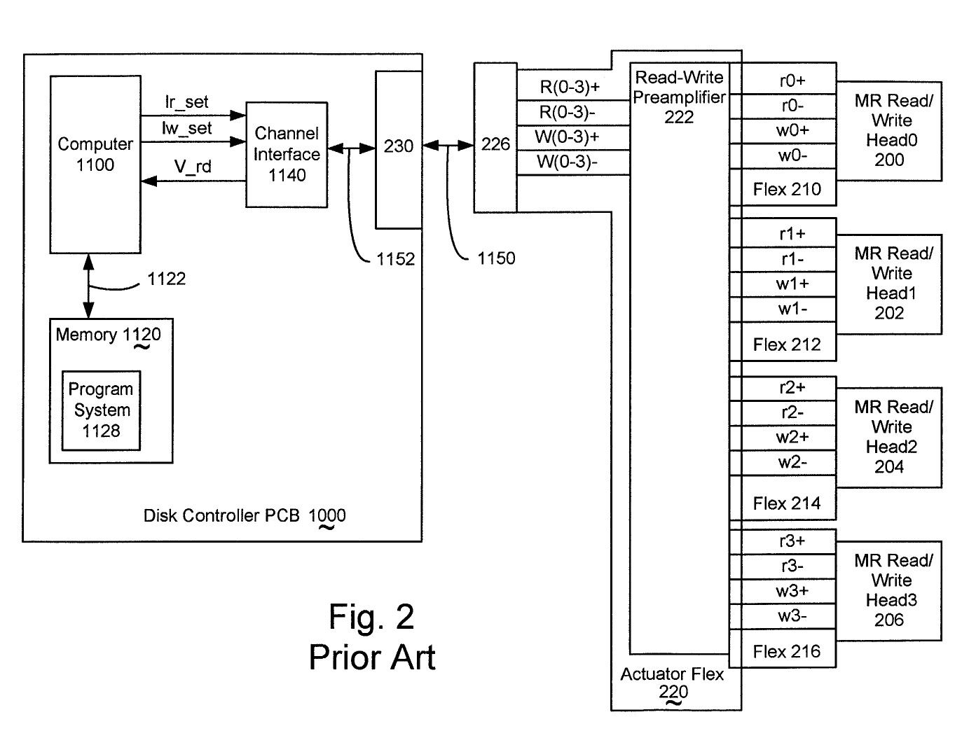

### DETAILED DESCRIPTION OF THE INVENTION

The invention includes an interconnection circuit minimizing the number of wire bonds on each line. The invention further includes a method of making the interconnection circuit minimizing the number of bonding steps required to make the interconnections between MR read-write heads, preamplifier and connector.

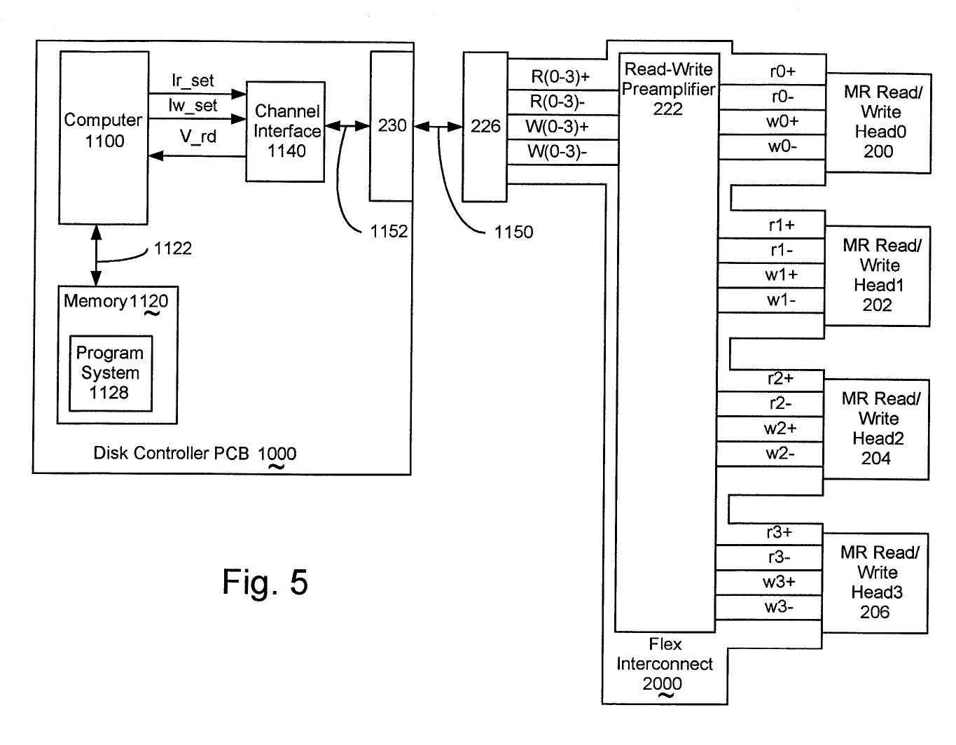

FIG. 5 illustrates a single flex interconnect circuit 2000 providing interconnection between connector 226 via preamplifier 222 and MR read-write head 200.

Note that FIG. 5 also illustrates a an alternative schematic view of flex interconnection substrate 2000 with bonding sites for connector 226, preamplifier 222 and MR read-write head 200.

A single flex interconnection circuit 2000 bonds to connector 226, electronic components including at least preamplifier 222 and at least one MR read-write head 200. Flex interconnection circuit 2000 provides the least number of bonds for each of the lines involved.

The invention includes the flex interconnection substrate with bonding sites for connector 226, electronic components and MR read-write heads. The electronics components include at least a preamplifier 222.

The electronics component collection may further include at least one capacitor. The electronics component collection may also further include at least one resistor.

Flex interconnection circuit 2000 includes a flex interconnection substrate with the following bonding to the substrate: connector 226, an electronics component collection including at least preamplifier 222 and at least one MR read-write head. The bonding of each of these is done at a specific bonding site. As will be apparent to one of skill in the art, when multiple MR read-write heads are being bonded, there are separate, though similar, bonding sites for each of the MR read-write heads.

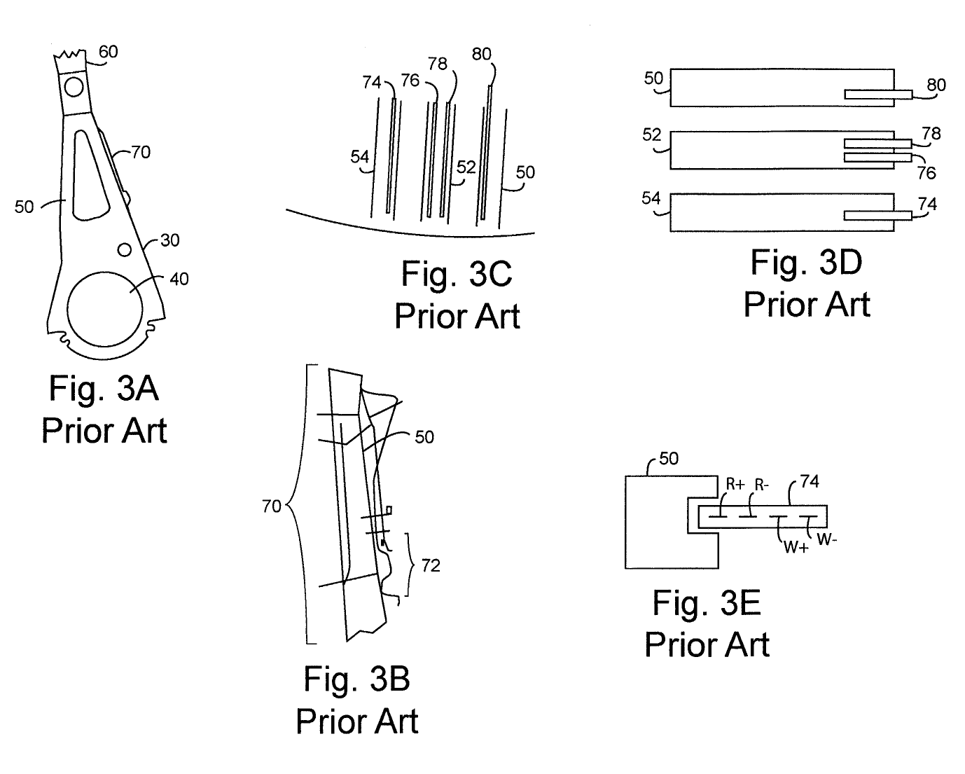

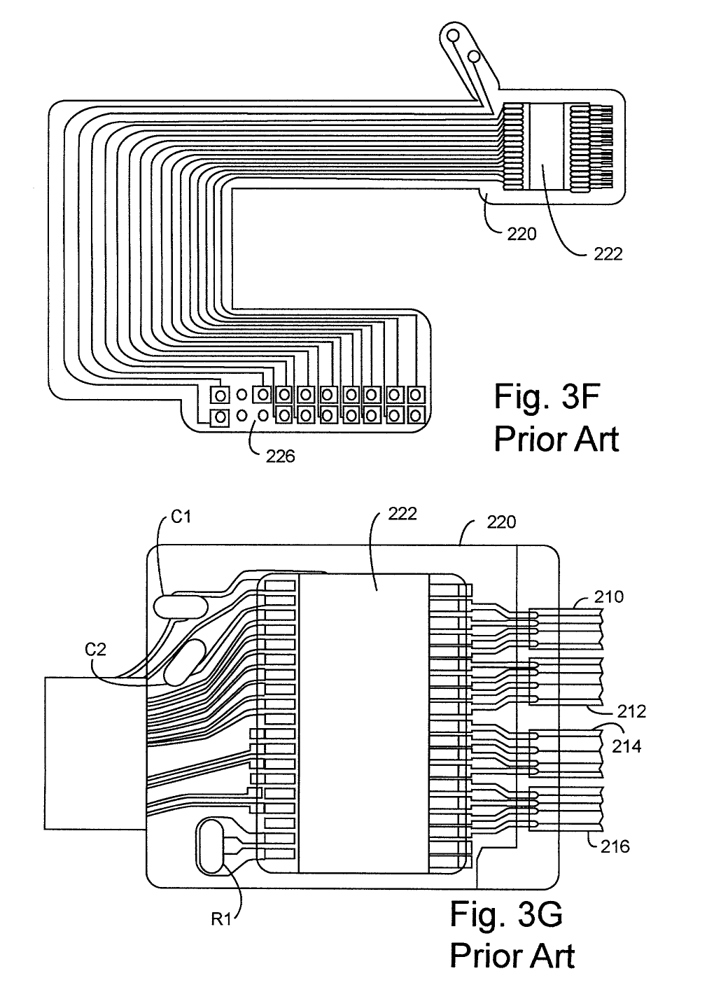

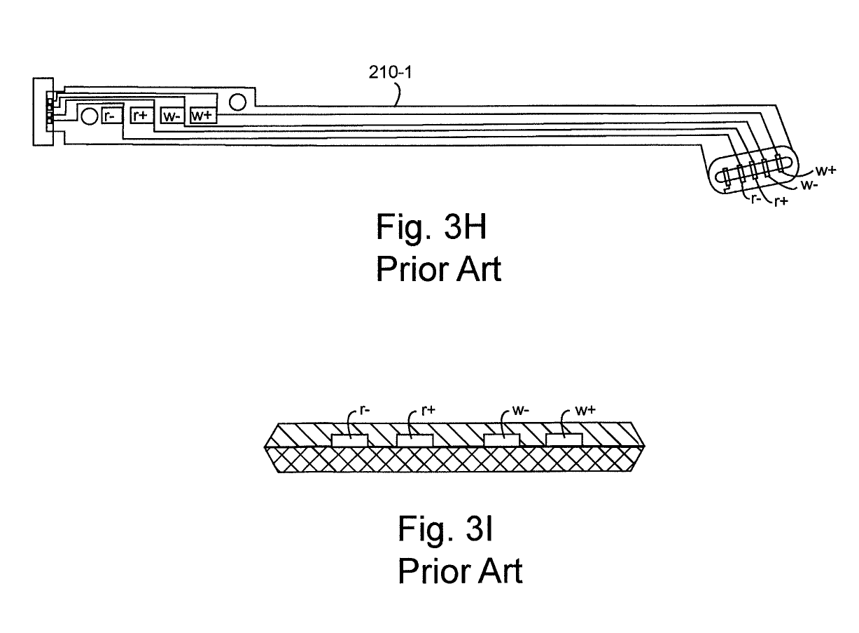

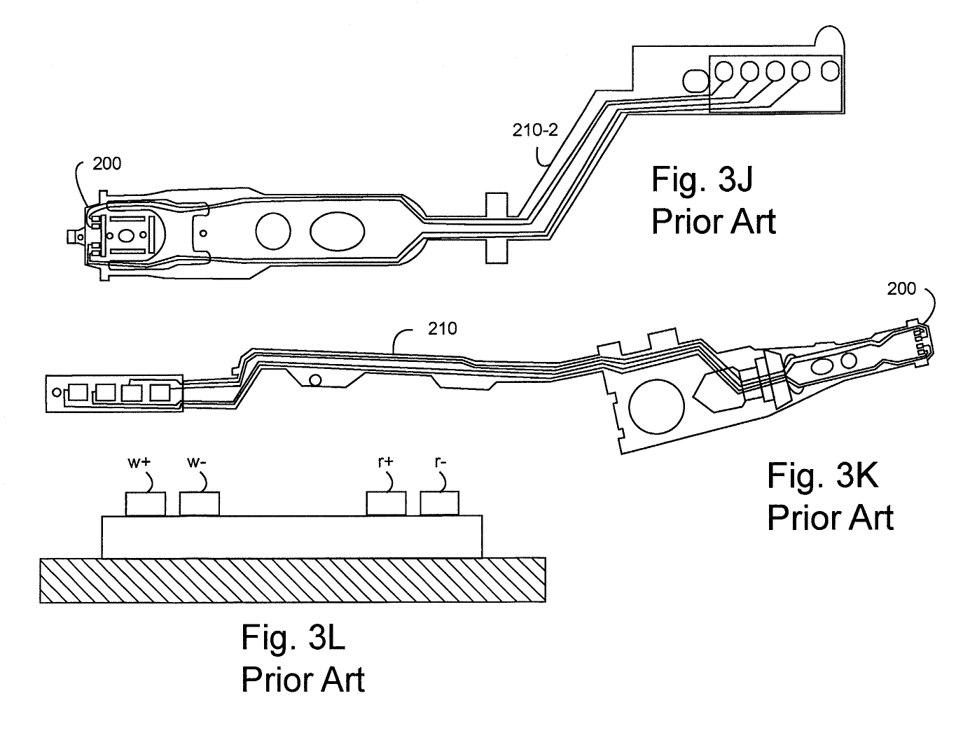

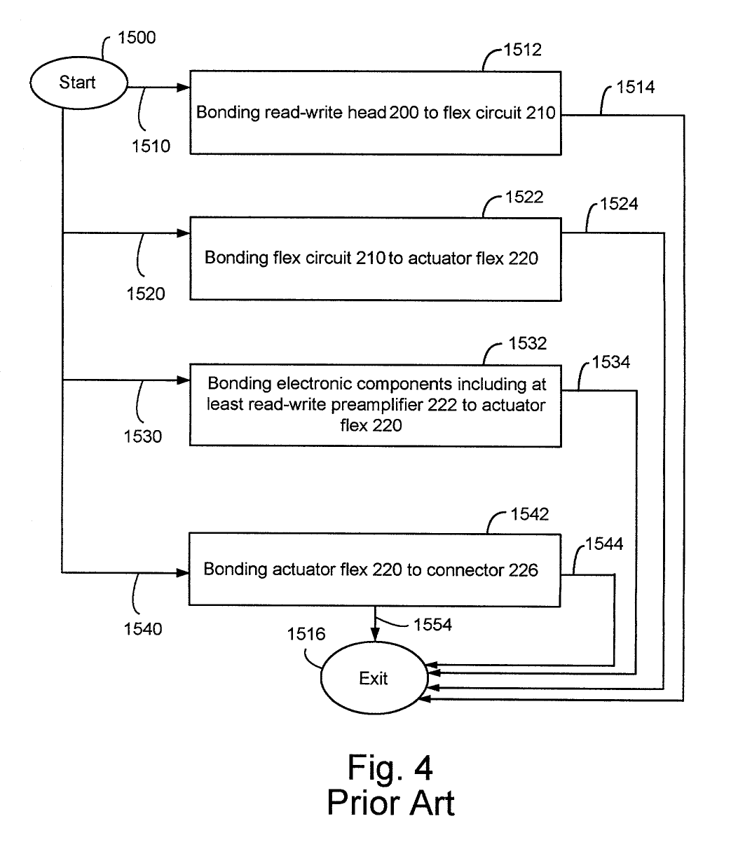

FIG. 3F illustrates a schematic view of a preferred bonding site for connector 226. FIG. 3G illustrates a schematic view of a preferred bonding site for an electronic components collection including preamplifier 222, two capacitors C1 and C2, as well as, resistor R1. FIG. 3H illustrates a schematic view of a preferred bonding site for MR read-write head 200.

The flex interconnection circuit 2000 couples connector 226 with preamplifier 222 through the bonding of connector 226 and preamplifier 222 to the flex interconnection substrate.

It is preferred that preamplifier 222 support a coupled communication via connector 226 based upon the following pin-out from reading FIG. 3F bonding site for connector 226 from left to right, top row of pins on the

| VC+ | VC− |
|---|---|
| GND | GND |
| GND | VSS(−5 V) |
| FLT/DBHY/TEMP | VDD(+5 V) |
| GND | WDY |
| MRB/FAST | WDX |
| SCLK | SDATA |
| R/W | SDEN |
| No Connect | RDY |
| WSRV/ABHV | RDX |

Table One illustrates a preferred pinout for connector 226 providing a coupling to preamplifier 222.

Preamplifier 222 may preferably be the 81G5014 integrated circuit manufactured by Marvell Semiconductor. The capacitance of C1 and C2 may preferably be 0.01 micro-Farads to within acceptable tolerances. The resistance of R1 may preferably be 12.4K Ohms to within acceptable tolerances. Each of these electronics component collection members is preferably packaged in a surface mount compatible package.

The flex interconnection circuit 2000 couples preamplifier 222 with MR read-write head 200 through the bonding of preamplifier 222 and MR read-write head 200 to the flex interconnection substrate. FIG. 3H illustrates a preferred bonding site for MR read-write head 200.

FIG. 31 illustrates a preferred cross section view of the read differential signal pair r− and r+ and the write differential signal pair w+ and w− of the flex interconnection substrate coupling a MR read-write head bonding site with the preamplifier bonding site.

The preferred base thickness beneath these signal pairs is from 15 to 25 micrometers, with a preferred overlay above the signal pairs from 5 to 33 micrometers. The preferred read trace width is from 100 to 125 micrometers, with preferred spacing between the read differential signals from 40 to 75 micrometers. The preferred spacing between the read and write differential signal pairs is from 100 to 170 micrometers. The preferred write signal width is from 100 to 125 micrometers. The preferred spacing between write differential signals is from 40 to 75 micrometers.

While the read and write differential signal traces may be made from several metals including copper, aluminum, silver and gold, the preferred composition is copper, with a gold trace at the bonding sites of the MR read-write heads.

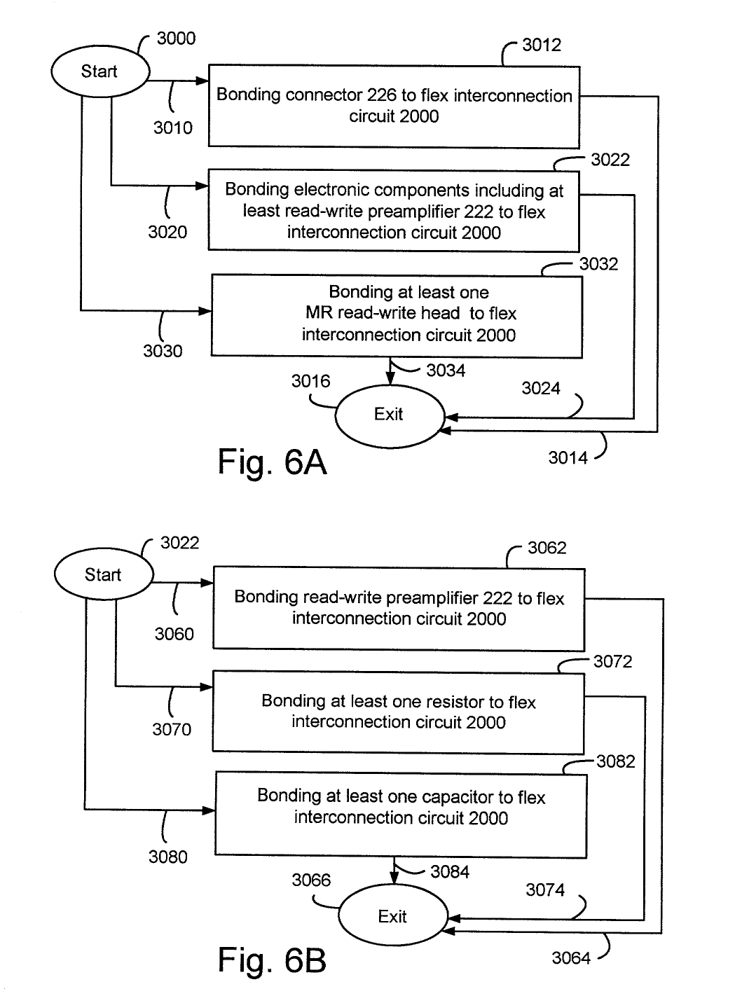

FIG. 6A illustrates a method 3000 for making flex interconnection circuit 2000, coupling connector 226 through preamplifier 222 with MR read-write head 200.

Arrow 3010 directs the flow of execution from starting operation 3000 to operation 3012. Operation 3012 performs bonding connector 226 to flex interconnection circuit 2000. Arrow 3014 directs execution from operation 3012 to operation 3016. Operation 3016 terminates the operations of this flowchart.

Arrow 3020 directs the flow of execution from starting operation 3000 to operation 3022. Operation 3022 performs bonding electronic components including at least read-write preamplifier 222 to flex interconnection circuit 2000. Arrow 3024 directs execution from operation 3022 to operation 3016. Operation 3016 terminates the operations of this flowchart.

Arrow 3030 directs the flow of execution from starting operation 3000 to operation 3032. Operation 3032 performs bonding at least one MR read-write head to flex interconnection circuit 2000. Arrow 3034 directs execution from operation 3032 to operation 3016. Operation 3016 terminates the operations of this flowchart.

As will be apparent to one of skill in the art, when more than one MR read-write head is involved, it is often preferable to bond them all concurrently to the flex interconnection substrate through operation 3032.

FIG. 6B illustrates a detail flowchart of operation 3022 of FIG. 6A for bonding electronic components to flex interconnection circuit 2000.

Arrow 3060 directs the flow of execution from starting operation 3022 to operation 3062. Operation 3062 performs bonding read-write preamplifier 222 to flex interconnection circuit 2000. Arrow 3064 directs execution from operation 3062 to operation 3066. Operation 3066 terminates the operations of this flowchart.

Bonding electronic components to flex interconnect circuit 2000 may further include at least one of the following operations of FIG. 6B.

Arrow 3070 directs the flow of execution from starting operation 3022 to operation 3072. Operation 3072 performs bonding at least one resistor to flex interconnection circuit 2000. Arrow 3074 directs execution from operation 3072 to operation 3066. Operation 3066 terminates the operations of this flowchart.

Arrow 3080 directs the flow of execution from starting operation 3022 to operation 3082. Operation 3082 performs bonding at least one capacitor to flex interconnection circuit 2000. Arrow 3084 directs execution from operation 3082 to operation 3066. Operation 3066 terminates the operations of this flowchart.

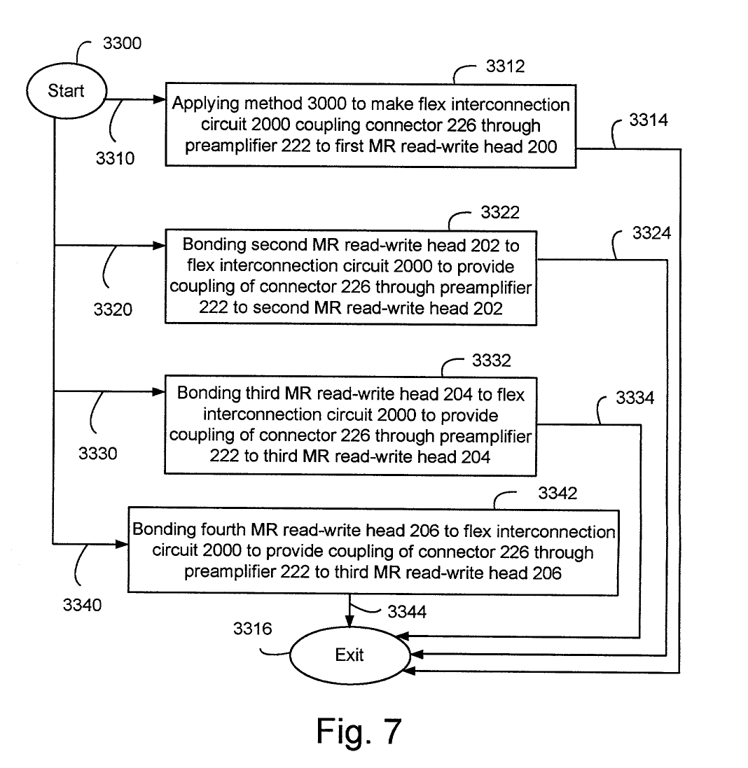

FIG. 7 illustrates a method 3300 for making an interconnection circuit, coupling connector 226 through preamplifier 222 with at least two MR read-write heads using the method 3000 of FIG. 6A.

Arrow 3310 directs the flow of execution from starting operation 3300 to operation 3312. Operation 3312 performs applying the method 3000 to make the flex interconnection circuit coupling connector 226 through preamplifier 222 to first MR read-write head 200. Arrow 3314 directs execution from operation 3312 to operation 3316. Operation 3316 terminates the operations of this flowchart.

Arrow 3320 directs the flow of execution from starting operation 3300 to operation 3322. Operation 3322 performs bonding a second MR read-write head 202 to the flex interconnection circuit 2000 to provide the coupling of connector 226 through preamplifier 222 to the second MR read-write head 202. Arrow 3324 directs execution from operation 3322 to operation 3316. Operation 3316 terminates the operations of this flowchart.

The method 3300 may further include the following operations of FIG. 7.

Arrow 3330 directs the flow of execution from starting operation 3300 to operation 3332. Operation 3332 performs bonding a third MR read-write head 204 to the flex interconnection circuit 2000 to provide the coupling of connector 226 through preamplifier 222 to the third MR read-write head 204. Arrow 3334 directs execution from operation 3332 to operation 3316. Operation 3316 terminates the operations of this flowchart.

Arrow 3340 directs the flow of execution from starting operation 3300 to operation 3342. Operation 3342 performs bonding a fourth MR read-write head 206 to the flex interconnection circuit 2000 to provide the coupling of connector 226 through preamplifier 222 to the fourth MR read-write head 206. Arrow 3344 directs execution from operation 3342 to operation 3316. Operation 3316 terminates the operations of this flowchart.

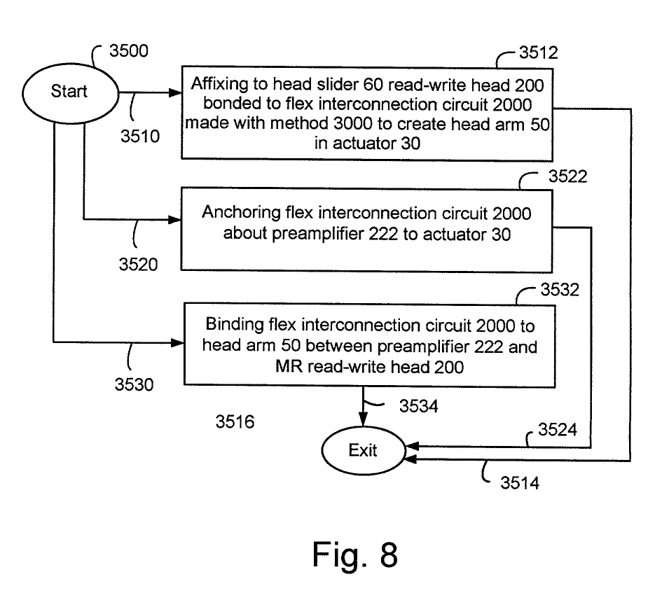

FIG. 8 illustrates a method 3500 for assembling a voice coil actuator using the product of the method 3000.

Arrow 3510 directs the flow of execution from starting operation 3500 to operation 3512. Operation 3512 performs affixing to a head slider 60 a MR read-write head 200 bonded to the flex interconnection circuit 2000 made with the method 3000 to create a head arm 50 in an actuator 30. Arrow 3514 directs execution from operation 3512 to operation 3516. Operation 3516 terminates the operations of this flowchart.

Arrow 3520 directs the flow of execution from starting operation 3500 to operation 3522. Operation 3522 performs anchoring the flex interconnection circuit 2000 about the preamplifier 222 to the actuator 30. Arrow 3524 directs execution from operation 3522 to operation 3516. Operation 3516 terminates the operations of this flowchart.

Arrow 3530 directs the flow of execution from starting operation 3500 to operation 3532. Operation 3532 performs binding the flex interconnection circuit 2000 to the head arm 50 between the preamplifier 222 and the MR read-write head 200. Arrow 3534 directs execution from operation 3532 to operation 3516. Operation 3516 terminates the operations of this flowchart.

The preceding embodiments have been provided by way of example and are not meant to constrain the scope of the following claims.

1. A method of making an interconnection circuit coupling a connector to an electronic component collection containing a preamplifier and further coupling said preamplifier to at least one MR read-write head, consisting essentially of the steps of:
bonding said connector to a flex interconnection circuit;
bonding said electronic component collection to said flex interconnection circuit; and
bonding said MR read-write head to said flex interconnection circuit;
wherein coupling said connector to said electronic component collection is provided by said steps bonding said connector and bonding said electronic component collection;
wherein coupling said preamplifier to said MR read-write head is provided by said steps bonding said electronic components collection and bonding said MR read-write head.

2. The method of claim 1,
wherein the step bonding said electronic component collection is further comprised of the step of:
bonding said preamplifier to said flex interconnection circuit.

3. The method of claim 2,
wherein said electronic components collection further includes at least one member of the collection comprising a resistor and a capacitor;
wherein the step bonding said electronic component collection is further comprised of at least one of the steps of:
bonding said resistor to said flex interconnection circuit; and
bonding said capacitor to said flex interconnection circuit.

4. The method of claim 1,
wherein the step bonding said MR read-write head is further comprised of the steps of:
bonding a second MR read-write head to said flex interconnection circuit;
wherein coupling said preamplifier to said second MR read-write head is provided by said steps bonding said electronics component collection and bonding said second MR read-write head.

5. A method of making an interconnection circuit coupling a connector to an electronic component collection containing a preamplifier and further coupling said preamplifier to at least two MR read-write heads, consisting essentially of the steps of:
applying the method of claim 1 to make said interconnection circuit coupling a connector to an electronic component collection containing a preamplifier and further coupling said preamplifier to a first MR read-write head; and
for each of said at least two MR read-write heads, except said first MR read-write head, bonding said MR read-write head to said flex interconnection circuit.

6. Said flex interconnection circuit coupling said connector, said electronics component collection and said MR read-write head as a product of the method of claim 1.

7. A method making an actuator using said flex interconnection circuit of claim 6, comprising the steps of:
affixing to a head slider said read-write head to create a head arm in said actuator;
anchoring said flex interconnection circuit about said preamplifier to said actuator; and
binding said flex interconnection circuit to said head arm at least once between said preamplifier and said MR read-write head.

8. Said actuator as a product of the process of claim 7.

9. A method of making a disk drive comprising the steps of:
using said actuator of claim 8; and
mechanically coupling said connector bonded to said flex interconnection circuit to a disk drive controller printed circuit board.

10. Said disk drive as a product of the process of claim 9.

11. A flex interconnection circuit substrate, comprising:
a connector bonding site coupled to an electronic component collection bonding site; and
said electronic component collection bonding site coupled to at least one MR read-write head bonding site;
wherein said electronic component collection includes at least one preamplifier.

12. The apparatus of claim 11,
wherein said electronic components collection further includes at least one member of the collection comprising a resistor and a capacitor.

13. A flex interconnection circuit, comprising:
said flex interconnection circuit substrate of claim 11;
a connector bonded to said connector bonding site;
said electronics component collection bonded to said electronics component collection bonding site comprising at least said preamplifier bonded to said electronic component bonding site; and
at least one MR read-write head bonded to said MR read-write head bonding site;
wherein said flex interconnection circuit couples said connector and said preamplifier;
wherein said flex interconnection circuit couples said preamplifier and said MR read-write head.

14. Said flex interconnection circuit of claim 13, further comprising:
a second MR read-write head bonded to said MR read-write head bonding site;
wherein said flex interconnection circuit couples said preamplifier and said second MR read-write head.

15. An actuator, comprising:
a head slider affixed with said MR read-write head of said flex interconnection circuit of claim 13;
said flex interconnection circuit anchored about said preamplifier to said actuator; and
at least one binding of said flex interconnection circuit between said preamplifier and said MR read-write head.

16. A disk drive, comprising:
said actuator of claim 15 coupled by said connector to a disk drive controller printed circuit board.
